(19) United States
(12) Patent Application Publication
(10) Pub. No.: US 2010/0161747 A1
(43) Pub. Date: Jun. 24, 2010

(54) SYSTEM AND METHOD FOR TWO-WAY ANONYMOUS COMMUNICATION

(76) Inventors: Cyril Rayan, San Jose, CA (US); William Curtis O'Linger, Coeur d'Alene, ID (US)

Correspondence Address: PHILLIP M. WAGNER, 1627 FOXWORTHY AVENUE, SAN JOSE, CA, 95118, US

(21) Appl. No.: 12/645,347

(22) Filed: Dec. 22, 2009

Related U.S. Application Data
(60) Provisional application No. 61/203,239, filed on Dec. 22, 2008.

(51) Int. Cl. G06F 15/16

(52) U.S. Cl. 709/206

(57) ABSTRACT

Some embodiments of a system and a method for two-way anonymous communication comprise a server adapted for Internet communication with a first electronic device operated by a user and a second electronic device operated by an observer. The server replaces identifying address information in messages sent from the first electronic device with a first alias. Identifying address information in messages sent from the second electronic device is replaced with a second alias. A user of the first electronic device is therefore unable to see identifying address information for the second electronic device in messages sent to the first alias from the second electronic device. Likewise, a user of the second electronic device is unable to see identifying address information from the first electronic device in messages sent to the second alias from the first electronic device.

### CROSS REFERENCE TO RELATED APPLICATIONS

This application claims the benefit of U.S. Provisional Application No. 61/203,239, filed Dec. 22, 2008 and incorporated herein in its entirety.

### FIELD OF THE INVENTION

Embodiments of the invention relate to a system and method for conducting anonymous two-way communication between separate electronic systems.

### BACKGROUND

There are many situations in which an observer may witness an event, condition, or activity that the observer believes could be of interest to someone else, but the observer may feel uncomfortable in disclosing information because of a perceived or real risk in being identified as the one who sent the information. For example, an employee may observe an unsafe working condition, but feels that his job would be threatened if he reported the condition to company management or to a government agency. Or, a person may witness a suspicious transaction on a street, but may hesitate to report the incident to a law enforcement agency out of fear that the persons involved in the transaction will seek retribution or take other undesirable action. Another example is a college student who is concerned about a roommate's remarks about harming himself or someone else, but who may not be sure if the roommate intends to act and or who may not want to be recognized as having reported remarks made in confidence.

From the point of view of an organization involved in law enforcement, security, emergency response, consumer relations, loss prevention, medical assistance or intervention, or other organizations whose function is to interact with members of a community or other identifiable group, information is most valuable when it is new. It may therefore be in an organization's interest to encourage prompt disclosure of information from the community with which it interacts, for example to address a hazardous, undesirable, or potentially illegal situation before it develops into something worse. Furthermore, disclosed information needs to be assessed for urgency and reliability and correlated with other related information to build as complete a picture of a situation as possible before deciding on a course of action.

Systems and methods for collecting information from observers who wish to remain anonymous are known. For example, a tip hotline may be used to receive phone calls about suspicious activity, potential regulatory violations, feedback from customers, and so on. Or, interested observers may be able to submit information on a page in an Internet web site or by sending a text message from a cell phone. However, a person submitting information by such means may not feel confident that her identity will be protected. For example, in the case of a web site for reporting security problems, a person may feel concern that his identity may be revealed by backtracking IP addresses from the web site to his computer or smart phone. Or, a person may feel that she does not want to be observed making a telephone call in view of the person whose activity she is reporting.

Systems known in the art for receiving information by text messages sent in accord with Simple Message System (SMS) or Multimedia Messaging System (MMS) protocols may lose information sent in a text message if the receiving system is not available for receiving messages, is overwhelmed by too many incoming messages, or if there is a communications fault in the cellular telephone network. For example, information contained in text messages sent in response to observations of an unsafe condition at a sporting event may be lost if many people attempt to send text messages to a security office at the same time.

Systems known in the art for receiving information by voice message or email may suffer from slow response by the intended recipients of information sent by an observer. Voice mail systems must be accessed to hear messages from observers. Email inboxes must be accessed to see messages sent by observers. There may be a relatively long delay from the time an observer sends information until the intended recipient checks for messages. Furthermore, the observer may have to wait a relatively long time to receive feedback on his information, for example an acknowledgement that a message was viewed by a person who could take action on the message's contents or a reply informing the observer of action to be taken by the recipient. Systems known in the art generally have such long time intervals between the submission of information by an observer, evaluation of the information by a recipient, and feedback to the observer, that real-time two-way communications are impractical. Some systems known in the art require a user at an organization to access information submitted by observers from a computer, making it difficult for a person in the field, for example a law enforcement officer driving a vehicle, to interact promptly with an observer, such as requesting additional information from the observer.

What is needed is a system and method for anonymous two-way communication that protects the identities of a party sending the information and a party receiving the information. What is further needed is a system and method that reliably transmits information between parties without losing the information. What is also needed is a system and method that enables anonymous two-way communication in approximately real time.

### SUMMARY

Some embodiments of a system and a method for two-way anonymous communication comprise a server adapted for communication over the Internet with a first electronic device operated by a user and a second electronic device operated by an observer. The server assigns a first alias to the first electronic device, replacing identifying address information in messages sent from the first electronic device with the first alias. The server also assigns a second alias to the second electronic device, replacing identifying address information in messages sent from the second electronic device with the second alias. A user of the first electronic device is therefore unable to see identifying address information for the second electronic device in messages sent to the first alias from the second electronic device. Likewise, a user of the second electronic device is unable to see identifying address information from the first electronic device in messages sent to the second alias from the first electronic device.

Some embodiments of the invention are adapted to send and receive SMS and MMS messages from cell phones, personal digital assistants (PDAs), and similar communication-enabled portable devices. SMS and MMS messages are converted to email format to take advantage of the capacity of the Internet to rapidly and reliably deliver large volumes of email.

Some embodiments of the invention include an administrator console for selectively interacting with the server. The administrator console may optionally be used to specify an electronic device to be used for notification of a user that an anonymous message has been received from an observer. The administrator console may also optionally be used to assign trust levels to an alias corresponding to a selected observer, and to process messages differently according to the assigned trust level. The administrator console may further be used to exchange messages with an alias corresponding to a selected observer, to assign classification categories for anonymous messages received from one or more observers or for messages related to different events or activities, and to display and count messages by selected classification category.

Some embodiments of the invention comprise a product comprising a computer readable media for managing anonymous two-way communication. Other embodiments of the invention comprise steps in a method for anonymous two-way communication between at least two electronic devices, for preventing identifiable address information from a selected electronic device from being transmitted to another selected electronic device.

This section summarizes some features of the embodiments of the invention. These and other features, aspects, and advantages will become better understood with regard to the following description and upon reference to the following drawings, wherein:

### BRIEF DESCRIPTION OF THE DRAWINGS

FIG. 1 is a block diagram of an example of an apparatus in accord with an embodiment of the invention.

FIG. 2 is a diagram showing times related to real-time communication.

FIG. 3 illustrates an example of steps in accord with an embodiment of the invention.

FIG. 4 continues the example of FIG. 3.

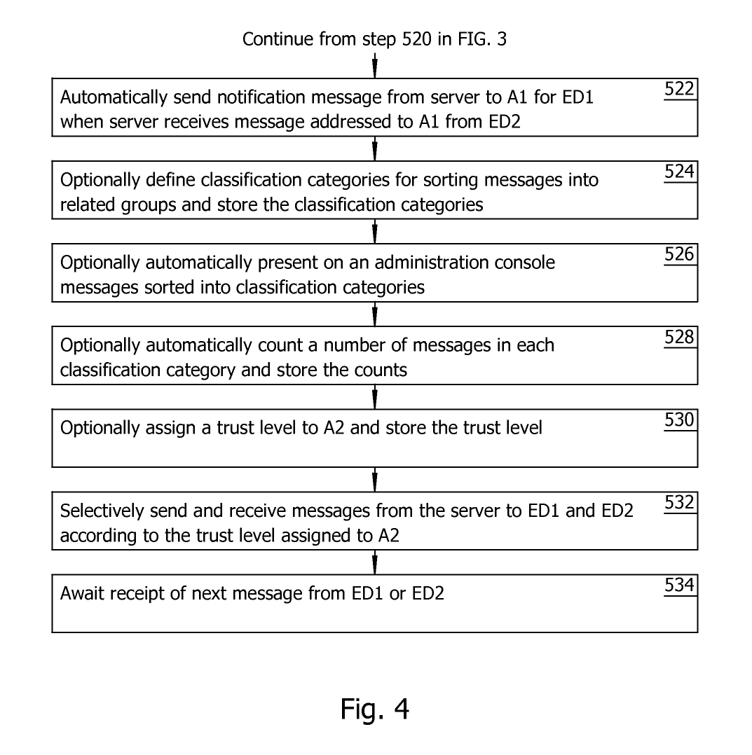

### DESCRIPTION

Embodiments of the invention include a system and a method for anonymous two-way communication between two or more electronic devices. Embodiments of the invention are advantageous for collecting information from observers who may wish to protect themselves by concealing their identities. Other advantages of an anonymous two-way communication system and method in accord with an embodiment of the invention include sending and receiving anonymous SMS or MMS messages from a cell phone with a low risk of the message being lost en route to its intended recipient, assignment of classification categories to messages, events, activities, and observers of interest to a particular organization, and capacity for receiving a large number of messages related to an incident or activity reported approximately simultaneously by many different observers.

Examples disclosed herein generally refer to communications between two different electronic devices, each device operated by a different person or persons. It will be appreciated after reading the following disclosure that embodiments of the invention are readily adaptable to two-way communication between more than two electronic devices interacting with respect to a single incident, hazard, activity, or other set of related observations, or for sending and receiving messages related to many separate incidents, activities, etc. In examples to follow, a reference to a user is representative of a person in an organization who desires to solicit and collect information, for example, but not limited to, a law enforcement agency, a security agency, an educational institution, a retail store, and so on. In general, a user is someone who has access to an administrator console that is part of an embodiment of the invention. A reference to an observer is representative of a person who wishes to report information that may be of interest to a user, for example, but not limited to, a student at a university, an employee of a company, a customer at a retail store, or a resident of a community. In general, an observer may choose to interact with an embodiment of the invention through an electronic device operated by the observer in order to send information to a selected user without either party being able to learn identifying address information about the other from the message's source and destination addresses.

For purposes of description herein, identifying address information refers to a telephone number, for example a cell phone number, a phone number for service provided by the Public Switched Telephone Network (PSTN) or through Voice Over Internet Protocol (VOIP), an email address, an Internet address, a short code corresponding to a phone number, or similar identifying information that is appended to a message to be sent through a wireless or wired communication system for the purpose of identifying the origin and destination of the message. Identifying address information is not intended to refer to information which an observer or user deliberately inserts into the body of a message, or information in an attachment to a message, such as a person's name, a building address, a vehicle license plate number, and so on, either visible in a photograph or other media attached to a message or included in a document attached to a message.

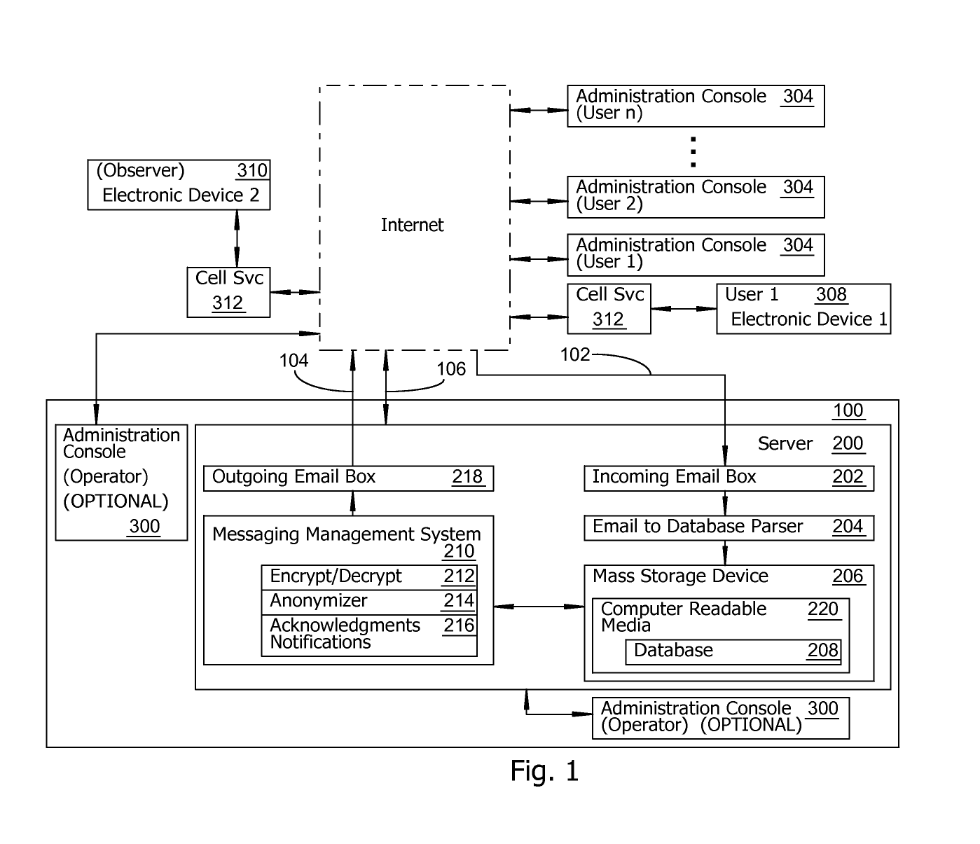

An example of an apparatus in accord with an embodiment of the invention is shown in FIG. 1. In the example of FIG. 1, a system for anonymous two-way communication 100 includes a server 200 and a first administration console 300 connected for data communication with the server 200. The first administration console 300 is provided for use by an operator responsible for management of the server 200. A second, optional administration console 304 is provided for access to and use of an embodiment of the invention by a user. As suggested in FIG. 1, in integer number “n” of administration consoles 304 may optionally be connected for data communication with the server 200. Each of the “n” user administration consoles may optionally be separately adapted to the needs and preferences of a particular user. Each of the “n” optional user administration consoles 304 communicate through an Internet communication link 306 to the Internet and thence to the server 200. The operator administration console 300 may alternatively be directly connected to a communications port on the server 200, or be connected to the server through an Internet connection, for example an Internet connection 106 between the server 200 and the Internet. Examples of an administration console suitable for use with an embodiment of the invention include, but are not limited to, a server with a keyboard and display, a desktop computer with a keyboard and display, a portable computer, and a smart phone, that is, a cellular telephone adapted for connection the Internet and including browser software for interacting with Internet web sites.

FIG. 1 illustrates some of the functions performed by subsystems in the server 200. An input connection 102 from the Internet carries data related to email messages received from a first electronic device 308 associated with a user and other email messages received from a second electronic device 310 associated with an observer. Examples of electronic systems which may be used to exchange messages anonymously with an embodiment of the invention include, but are not limited to, cell phones having SMS or MMS capability, smart phones, desktop computers, portable computers, game consoles, and other communications-enabled devices. Some of the messages received on the input connection 102 include identifying address information in the sender's address, the destination address, or both. Other messages received on the input connection 102 have a sender's address, a destination address, or both, expressed as aliases.

Messages on the input connection 102 are received into an incoming email box 202 in the server 200. A message received from an observer is placed into an inbox reserved for a selected user according to address information supplied in the destination portion of the received message. Email messages are then sent to a database parser 204, which separates a received message into parts and enters the separated parts into a database 208 on a mass storage device 206 comprising computer-readable media 220. Some of the actions performed by the database parser 204 include separating the sender's address and recipient's address from the body of the message, and putting these parts into a database record for the message.

The database 208 includes identifying address information for electronic devices communicating with each other through the server 200. A messaging management system 210 performs encryption of data to be stored in the database 208 on the mass storage device 206, in order to make it difficult to access identifying address information in the event of unauthorized access of the database. Encrypted data to be retrieved from the database 208 is decrypted by the messaging management system 210. Data encryption and decryption is performed by an encryption/decryption module 212 in the messaging management system 210.

A unique alias is assigned to each user's administration console 304. A unique alias may optionally be assigned to another electronic device controlled by a user, for example a cell phone adapted for sending and receiving SMS or MMS messages. A user may optionally specify through the user's administration console 304 whether email messages sent from the server 200 are sent only to the user's administration console or are sent to the administration console as email and to another electronic device as SMS or MMS messages.

The messaging management system 210 also includes an anonymizer module 214 for forming anonymous messages from incoming messages containing identifying address information. The anonymizer module 214 assigns a unique alias to a first message received from an electronic system under control of an observer. Subsequent communications with the observer's electronic system refer to the same alias. An outgoing message from the server 200 passes through the anonymizer module 214, where identifying address information related to the intended recipient is substituted for an alias entered by the message's sender. After the recipient's identifying address information is entered into the message, the message is transferred to an outgoing email box 218. From there, the email message, which contains identifying information for the recipient and an alias for the sender, passes through an output connection 104 from the server 200 and then to the Internet. The outgoing message is then delivered to the observer's electronic device.

The server 200 inputs and outputs email messages on its Internet connections (102, 104). A message from a cell phone will be in SMS, or optionally MMS, format. An SMS message sent from an electronic device to the server 200 will be converted to an email message by a cellular telephone service provider. For example, an SMS message from an observer's electronic device, represented by electronic device 2 310 in FIG. 1, is converted to an email message by a cellular service provider 312 in FIG. 1. Similarly, an SMS message sent from a user's electronic device, represented by electronic device 1 308 in FIG. 1, is converted by a cellular service provider 312 to email format for transmission on the Internet. Messages may also be converted from email format to SMS format by a cellular service provider to send an SMS message to a cell phone. Identifying address information related to the observer's cell phone will be converted to identifying address information for sending an email over the Internet by the cellular telephone service provider. An email message sent from the server 200 to a cell phone first has an alias replaced with a corresponding email address in the anonymizer 214, the email is received by the cellular telephone service provider, and the cellular telephone service provider converts the email to SMS or MMS format and sends the message to the observer's cell phone.

Messages which pass through the anonymizer 214 are referred to herein as anonymous messages because an electronic device from which a message originates uses an alias as a destination address instead of identifying address information. Identifying address information for the intended recipient of a message is not known to the sender. Similarly, the sender's identifying address information is not known to the recipient, who instead sees the sender's alias, inserted in the message by the anonymizer 214 in the messaging management system 214. Two-way communication between a user and an observer with substitutions of aliases for identifying address information as described herein are therefore referred to as anonymous two-way communication.

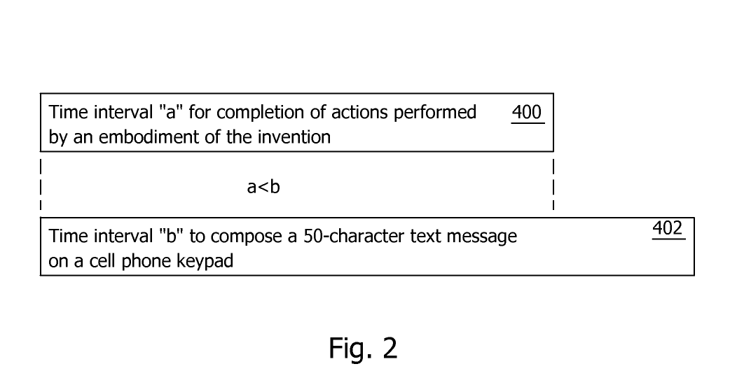

It is an object of the embodiments of the invention for anonymous two-way communication to operate in approximately real time. As used in reference to embodiments of the invention, approximately real time two way communication refers to a time interval for completion of actions performed by a two-way anonymous communication system that is less than an amount of time for a person to compose a representative text message on a cell phone. FIG. 2 illustrates the meaning of approximately real time in the present context. A time interval “a” 400 corresponds to combined system delays and communication delays in conveying a message from a first electronic device to the server to a second electronic device. A time interval “b” 402 corresponds to an average amount of time required for entry of a message comprising 50 text characters using a cell phone's keypad. Communication between two electronic devices through the server component of an embodiment of the invention are considered to be approximately real time for interval “b” 402 greater than or equal to interval “a” 400. One will appreciate that the example of a 50 character text message is not intended to be a firm limiting value for a size of a text message, but is instead intended to be representative of a short but meaningful text message comprising about ten words.

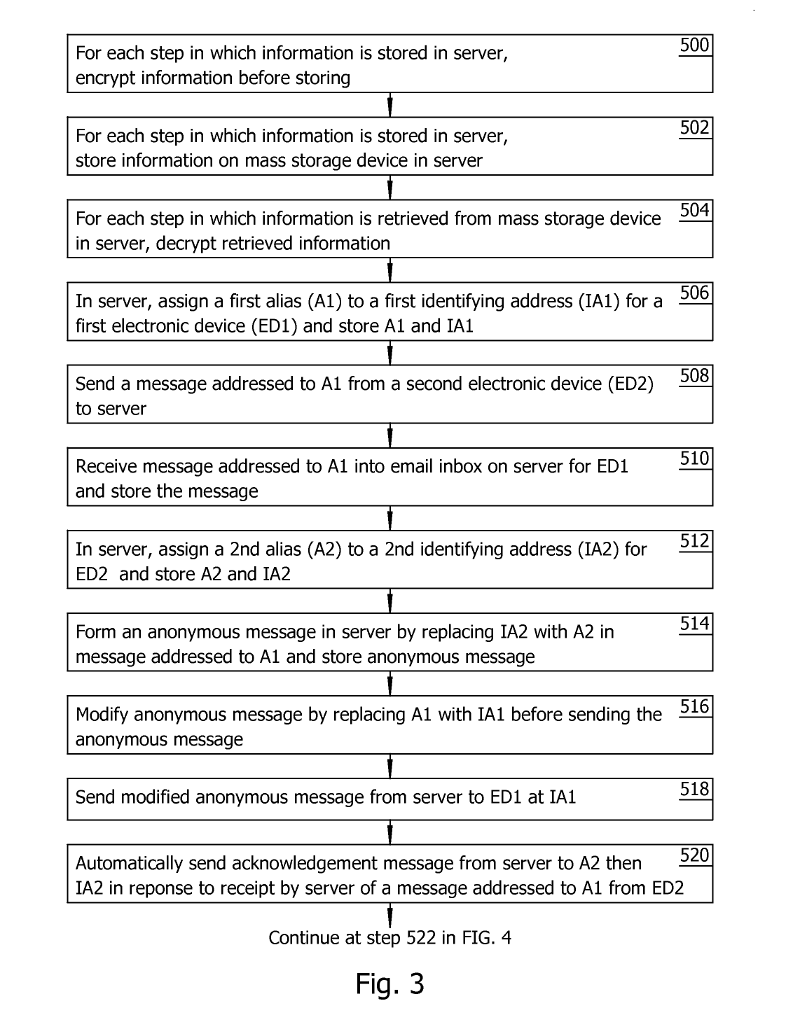

Some embodiments of the invention comprise steps in a method for anonymous two-way communication. FIG. 3 illustrates an example of steps in accord with an embodiment of the invention.

The example of a method begins with step 500, wherein for each subsequent step in which information is stored in a server, encrypting information received by the server before storing the information in the server.

Next, in step 502, for each subsequent step in which information is stored in the server, storing the encrypted information on a mass storage device in the server.

Next, in step 504, for each subsequent step in which information is retrieved from storage in the server, decrypting information retrieved by the server from the mass storage device in the server.

Next, in step 506, assigning in the server a first alias to a first identifying address for a first electronic device and storing the first identifying address and first alias.

At step 508, the method continues by sending a message addressed to the first alias from a second electronic device to the server.

At step 510, the message addressed to the first alias is received into an email inbox on the server for the first electronic device and storing the message.

At step 512, continue by assigning in the server a second alias to a second identifying address for the second electronic device and storing the second alias and second identifying address.

Next, at step 514, an anonymous message is formed in the server by replacing the second identifying address with the second alias in the message addressed to the first alias and storing the anonymous message.

Next, at step 516, prior to sending the anonymous message, the anonymous message is modified by replacing the first alias with the first identifying address.

At step 518, the method continues by sending the modified anonymous message from the server to the first electronic device at the first identifying address.

At step 520, the server automatically sends an acknowledgment message to the second alias and thence to the second identifying address in response to receipt of a message on the server of a message addressed to the first alias from the second electronic device.

At step 522, a notification message is automatically sent from the server to the first alias, corresponding to the first electronic device, when a message addressed to the first alias has been received by the server from the second electronic device.

At step 524, the method includes the optional step of defining classification categories for sorting messages into related groups.

At step 526, the method includes the optional step of automatically presenting on an administrator console messages sorted into classification categories.

At step 528, the method includes the optional step of automatically counting a number of messages in each classification category.

At step 530, a trust level is optionally assigned to the second alias.

At step 532, messages are selectively sent from the server to the first and second electronic devices according to the trust level assigned to the second alias.

At step 534, the server awaits receipt of a next message from either the first electronic device or the second electronic device.

One will appreciate that many alternative embodiments of a method in accord with an embodiment of the invention may be created by performing steps selected from the preceding example in different sequential combinations.

Unless expressly stated otherwise herein, ordinary terms have their corresponding ordinary meanings within the respective contexts of their presentations, and ordinary terms of art have their corresponding regular meanings.

What is claimed is:

1. An apparatus for two-way communication, comprising:
a server having a mass storage device;
storage locations in said mass storage device for a first identifying address, a second identifying address, a first message, a second message, a first anonymous message, and a second anonymous message; and
an administration console connected for bidirectional data communication with said server,
wherein said administration console is adapted to save information to and retrieve information from said mass storage device,
said server is adapted for Internet communication with other electronic systems,
said server is adapted to replace a first identifying address with a first alias in a first message received from a first electronic device, thereby creating a first anonymous message,
said server is adapted to replace a second identifying address with a second alias in a second message from a second electronic device, thereby creating a second anonymous message,
said server is adapted to save the first and second anonymous messages, the first and second aliases, and the first and second identifying addresses on said mass storage device in said storage locations,
said server is adapted to send messages addressed to the first alias to the first electronic device,
said server is adapted to send messages addressed to the second alias to the second electronic device,
said server is adapted to send the first anonymous message to the second electronic device and then to send the second anonymous message to the first electronic device.

2. The apparatus for two-way communication of claim 1, wherein said server is adapted to send an automatic reply addressed to said first alias.

3. The apparatus for two-way communication of claim 2, wherein said server is adapted to automatically send a notification message to a selected electronic system for informing a user of the selected electronic system that an anonymous message has been received from the first alias.

4. The apparatus for two-way communication of claim 3, wherein said server is adapted to receive the first message as an Internet email corresponding to a message sent from a cellular phone using the Short Message Service (SMS) communication protocol.

5. The apparatus for two-way communication of claim 3, wherein said server is adapted to receive the first message as an Internet email corresponding to a message sent from a cellular phone using the Multimedia Messaging Service (MMS) communication protocol

6. The apparatus for two-way communication of claim 4, wherein said server is adapted to encrypt information stored on said mass storage device and decrypt information retrieved from said mass storage device.

7. The apparatus for two-way communication of claim 6, wherein a length of a time interval for completion of actions performed by the two-way communication system is less than an amount of time for a person to compose a message to be sent, thereby enabling approximately real-time two-way communication between the first and second electronic devices.

8. The apparatus for two-way communication of claim 7, wherein said server is adapted to store a trust level related to the first alias on said mass storage device.

9. The apparatus for two-way communication of claim 8, wherein said server is adapted to accept a trust level from said administration console, to save the trust level with the first alias on said mass storage device, and to selectively block a message from the first alias when the first alias has a weak trust level.

10. The apparatus for two-way communication of claim 8, wherein said server is adapted to save a classification category assigned by an administrator with the first anonymous message from the first electronic device.

11. The apparatus for two-way communication of claim 10, wherein said server is adapted to create a numerical total of a number of messages having a selected classification category and to selectively transmit the numerical total to the administration console.

12. A product for managing anonymous two-way communication, comprising:
a computer-readable medium;
means, provided on the computer-readable medium, for creating a first alias from a first identifying address in a first message received by a server from a first electronic device;
means, provided on the computer-readable medium, for creating a second alias from a second identifying address in a second message received by the server from a second electronic device;
means, provided on the computer-readable medium, for replacing the first identifying address in the first message with the first alias, creating thereby a first anonymous message;
means, provided on the computer-readable medium, for replacing the second identifying address in the second message with the second alias, creating thereby a second anonymous message;
means, provided on the computer-readable medium, for replacing a destination address in the first anonymous message with the second alias;
means, provided on the computer-readable medium, for converting the second alias in the first anonymous message to the second identifying address, then sending the first anonymous message from the server to the second electronic device at the second identifying address.
means, provided on the computer-readable medium, for sending another anonymous message from the second electronic device to the server and thence to the first electronic device, in reply to the first anonymous message;
means, provided on the computer-readable medium, for automatically sending an acknowledgment message from a server to the first electronic device; and
means, provided on the computer-readable medium, for sending an automatic notification from the server to the second electronic device when an anonymous message addressed to the second alias by the first electronic device has been received by the server.

13. A method for anonymous two-way communication, comprising:
assigning in a server a first alias to a first identifying address for a first electronic device;
sending a message addressed to the first alias from a second electronic device to the server;
receiving the message addressed to the first alias into an email inbox on the server for the first electronic device;
assigning in the server a second alias to a second identifying address for the second electronic device;
forming an anonymous message in the server by replacing the second identifying address with the second alias in the message addressed to the first alias;
prior to sending the anonymous message, replacing the first alias with the first identifying address; and
sending the anonymous message from the server to the first electronic device at the first identifying address.

14. The method for anonymous two-way communication of claim 13, further comprising:
sending messages from the first anonymous alias to the second anonymous alias in less than an amount of time required for a person to compose a text message; and
sending messages from the second anonymous alias to the first anonymous alias in less than the amount of time required for a person to compose a text message, thereby enabling approximately real time two-way communication between the first electronic device and the second electronic device.

15. The method for anonymous two-way communication of claim 14, further comprising:
encrypting information received by the server before the information is stored in the server;
storing encrypted information on a mass storage device in the server; and
decrypting information retrieved by the server from the mass storage device in the server.

16. The method for anonymous two-way communication of claim 15, further comprising:
automatically sending an acknowledgment message from the server to the second alias and thence to the second identifying address in response to receipt of a message on the server of a message addressed to the first alias from the second electronic device.

17. The method for anonymous two-way communication of claim 16, further comprising:
automatically sending a notification message from the server to the first alias, corresponding to the first electronic device, when a message addressed to the first alias has been received by the server from the second electronic device.

18. The method for anonymous two-way communication of claim 17, further comprising:
defining classification categories for sorting messages into related groups;
automatically presenting on an administrator console messages sorted into classification categories; and
automatically counting a number of messages in each classification category.

19. The method for anonymous two-way communication of claim 17, further comprising assigning a trust level to the second alias.

20. The method for anonymous two-way communication of claim 19, further comprising selectively sending and receiving messages from the server to the first and second electronic devices according to the trust level assigned to the second alias.
